(19) United States
(12) Patent Application Publication
(10) Pub. No.: US 2020/0090091 A1
(43) Pub. Date: Mar. 19, 2020

(54) SOFTWARE APPLICATION FOR INTERCONNECTING CLOUD-BASED SOLUTIONS TO ON-PREMISE SYSTEMS THAT LACK A NATIVE API

(71) Applicant: Ernest Kofi Conduah, Alpharetta, GA (US)

(72) Inventor: Ernest Kofi Conduah, Alpharetta, GA (US)

(21) Appl. No.: 16/571,614

(22) Filed: Sep. 16, 2019

Related U.S. Application Data
(60) Provisional application No. 62/731,472, filed on Sep. 14, 2018.

(51) Int. Cl. G06Q 10/06; G06F 9/54; G06F 16/182; H04L 29/08

(52) U.S. Cl. CPC G06Q 10/06312; G06F 9/547; H04L 67/02; H04L 67/10; G06F 16/182

(57) ABSTRACT

A cloud-based application for interconnecting cloud-based enterprise resource planning (ERP) solutions to on-premise systems is provided. The ERP solutions are connected via an application programming interface (“API”) to on-premise systems that does not have a native API. The cloud-based application includes a user interface and a database retrievably storing data, logic, functionality to execute web services, and a light agent that has an API end-point preconfigured to communicate with the cloud-based application. The cloud-based application user interface allows the enterprise to choose the on premise ERP solution they are using. The light agent pulls data from the ERP to communicate via the API to the cloud-based application in communication with the on-premise systems.

### CROSS-REFERENCE TO RELATED APPLICATION

This application claims the benefit of priority of U.S. provisional application No. 62/731,472, filed 14 Sep. 2018, the contents of which are herein incorporated by reference.

### BACKGROUND OF THE INVENTION

The present invention relates to enterprise resource planning (ERP) systems and, more particularly, to an API adapter that provides on-premise ERPs with the ability to interconnect any cloud-based solution via an application programming interface (“API”) regardless of it's native API capabilities.

Enterprise resource planning (ERP) systems enable an enterprise to coordinate and manage resource and information functionality needed to operate business processes. EPR systems are designed to coordinate some or all of the resources, information, and activities needed to complete business processes, including accounting, manufacturing support, supply chain management, human resources, customer relationship management, and the like.

Cloud-based ERP systems typically provide a native API that developers may use to read, write, update, and/or remove data objects on the database level. on-premise ERP solutions however typically lack this API capability. Cloud-based solutions such as Bank Treasury Platforms are unable, however, to communicate with on-premise systems via an API unless the on-premise system is API-capable or “API enabled”. This makes it difficult and inefficient for systems without API capability to communicate with online, cloud-based services that may be desirable for their business. In other words, cloud-based systems can only “talk to” other systems that are API-enabled. And not being able to ‘talk to’ other systems without an API puts the users at a disadvantage because they need to rely on antiquated, insecure file transfer methods and/or protocols.

Specifically, existing cloud-based accounts-payables automation systems require an inefficient file exchange method for systems that are not already API-enabled. This is also not very secure as payment files are visible to users who are able to manipulate the data.

As can be seen, there is a need for a cloud applications to interconnect via API to on-premise systems that are not AP-enabled. The present invention instantly provides real-time, more secure API integration access for systems that are not API-enabled; thereby, enabling cloud-based solutions to “talk to” any other system regardless of its ability to connect via an API.

The API Adapter application of the present invention embodies a ‘light-agent’ that, when installed by an on-premise system, instantly gives the on-premise system API capabilities, thereby enabling API functionality to on-premise ERP systems that lack this feature and so provide for a more secure, real-time experience of a wide variety of cloud-based business solutions.

In sum, the present invention embodies a computer-implemented solution for an inherent computer-based problem, thereby improving the related technology through the method disclosed herein.

### SUMMARY OF THE INVENTION

In one aspect of the present invention, a server-implemented method for providing cloud-based web services to an on-premise system without a native API includes the following: receiving, by a cloud-based application, a light agent providing an API end-point preconfigured to communicate with the cloud-based application; communicating by way of the light agent with one or more ERP server; pulling information through the one or more ERP server, by way of the light agent, to the cloud-based application received by said on-premise system; and each ERP server comprising one or more web-services.

In another aspect of the present invention, the server-implemented method for providing cloud-based web services to an on-premise system without a native API includes the following: receiving, by a cloud-based application, a light agent providing an API end-point preconfigured to communicate with the cloud-based application; the cloud-based application provides a database retrievably storing data and logic; and a web-based user interface; communicating by way of the light agent with one or more ERP server via an ODBC connection or by accepting flat files; pulling information through the one or more ERP server, by way of the light agent, to the cloud-based application received by said on-premise system.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cloud-based API Adapter for interconnecting cloud-based Business solutions via an application programming interface (“API”) to on-premise systems that does not have a native API. The cloud-based API Adapter application includes a user interface and a database retrievably storing data, logic, functionality to execute web services, and a light agent that has an API end-point preconfigured to communicate with the cloud-based application. The cloud-based application user interface allows the enterprise to choose one or more custom cloud-based ERP solutions. The light agent pulls data from the ERP to communicate via the API to the cloud-based application in communication with the on-premise systems.

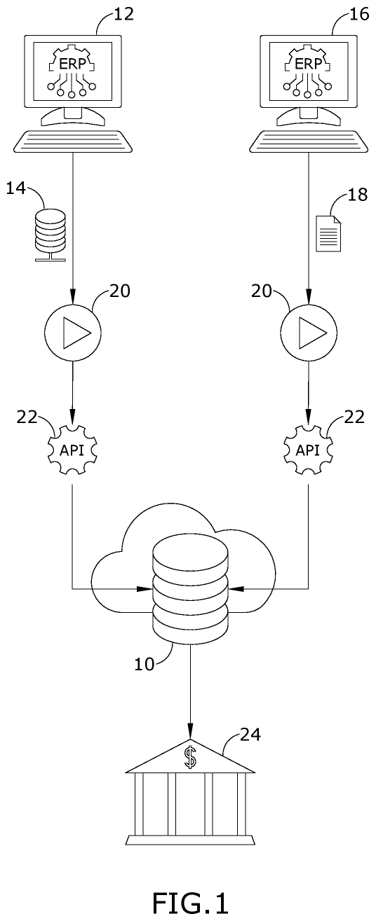

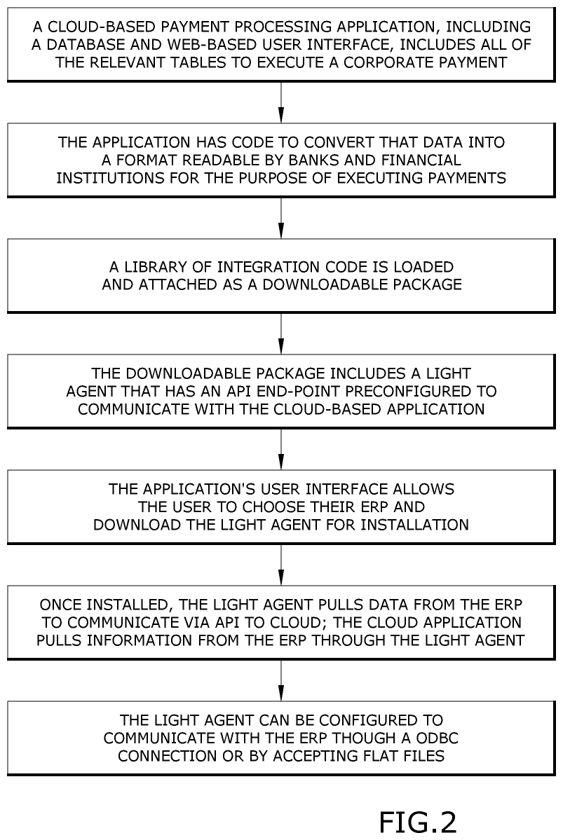

Referring to FIGS. 1 and 2, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

An enterprise 24, such as a financial institution interested in executing corporate payments, may be in communication with a cloud-based application 10. It should be understood that the enterprise 24 may be any business or organization in need of any enterprise-related process completion by way of managing any relevant resource, information, or the like through a web service; therefore, the enterprise 24 is not limited to the financial institutions and payment transactions services disclosed in the Figures.

The cloud-based application 10 may include a database retrievably storing data and logic, a web-based user interface, and relevant functionality (e.g., tables) to execute an activity needed by the enterprise 24. The cloud-based application 10 also provides code to convert data into a format readable by the enterprise 24 for the activity the enterprise 24 is interested in. A library of integration code may be loaded and attached as a downloadable package. The downloadable package includes a light agent 20 that has an API end-point 22 preconfigured to communicate with the cloud-based application 10. The cloud-based application 10 user interface allows the enterprise 24 to choose a custom enterprise resource planning (ERP) system 12, 16, etc., and to download the light agent 20 for installation.

Once installed, the light agent 20 pulls data from the ERP 12/16 to communicate via the API 22 to the cloud-based application 10. Specifically, the cloud-based application 10 pulls information from the ERP 12/16 through the light agent 20. The light agent 20 can be configured to communicate with the ERP 12/16 through an open database connectivity (ODBC) connection 14 or by accepting flat files 18.

This allows any on-premise system of the enterprise 24's customers not otherwise API-enabled to become instantly API-enabled after downloading and installing the light agent 20. The light agent 20 has code that connects to multiple processing systems of the enterprise 24's customers via the ODBC connection 14. The light agent 20 may run as a windows service and contain code to connect to the host ERP system via ODBC connection 14 or similar protocol, and extracts data from relevant tables in the ERP 12/16. The light agent 20 can then communicate via a built-in API connection 22 to the cloud-based application 10., which in turn can request data from the ERP 12/16 via the light agent 20 and to update the ERP 12/16 as needed based in part on transaction status.

Once an enterprise 24's customers haveinstalled the light agent 20, which will connect to their ERP 12/16 and access relevant data, the enterprise 24's customers can simply log on to a cloud user interface and click on a button that will cause the relevant cloud-based application 10 to communicate with the ERP 12/16 via the light agent 20 to get the relevant data into the cloud for further processing .

The computer and cloud-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A server-implemented method for providing cloud-based web services to an on-premise system without a native application programming interface (“API”), comprising:
receiving, by a cloud-based application, a light agent providing an API end-point preconfigured to communicate with the cloud-based application;
communicating by way of the light agent with one or more enterprise resource planning (“ERP”) server;
pulling information through the one or more ERP server, by way of the light agent, to the cloud-based application received by said on-premise system; and
each ERP server comprising one or more web-services.

2. The server-implemented method of claim 1, wherein the communicating with the one or more ERP service is by way of an open database connectivity (“ODBC”) connection or by accepting flat files.

3. The server-implemented method of claim 1, wherein the cloud-based application comprises:
a database retrievably storing data and logic; and
a web-based user interface.

4. The server-implemented method of claim 1, wherein the light agent runs as a windows service on the on-premise system.

5. The server-implemented method of claim 1, wherein the on-premise system comprises financial institutions' corporate customers, and wherein the one or more web-services comprises functionality for executing corporate payments.

6. A server-implemented method for providing cloud-based web services to an on-premise system for corporate customers of financial institutions without a native application programming interface (“API”), comprising:
receiving, by a cloud-based application, a light agent providing an API end-point preconfigured to communicate with the cloud-based application;
the cloud-based application comprises:
a database retrievably storing data and logic; and
a web-based user interface;
communicating by way of the light agent with one or more enterprise resource planning (“ERP”) server via an open database connectivity (“ODBC”) connection or by accepting flat files.;
pulling information through the one or more ERP server, by way of the light agent, to the cloud-based application received by said on-premise system;
each ERP server comprising one or more web-services comprising functionality for executing corporate payments through the financial institution, wherein the light agent runs as a windows service on the financial institution.
